(19) United States
(12) Patent Application Publication
(10) Pub. No.: US 2014/0125435 A1
(43) Pub. Date: May 8, 2014

(54) EQUALIZER ASSEMBLY FOR LOSS-COMPENSATION OF HIGH-FREQUENCY SIGNALS GENERATED IN TRANSMISSION CHANNELS

(71) Applicant: HON HAI PRECISION INDUSTRY CO., LTD., New Taipei (TW)

(72) Inventors: KUN-HUNG TSAI, New Taipei (TW); PO-CHUAN HSIEH, New Taipei (TW)

(73) Assignee: HON HAI PRECISION INDUSTRY CO., LTD., New Taipei (TW)

(21) Appl. No.: 13/726,618

(22) Filed: Dec. 26, 2012

(30) Foreign Application Priority Data
Nov. 2, 2012 (TW) 101140686

(51) Int. Cl. H04B 3/14

(52) U.S. Cl. CPC H04B 3/14
USPC 333/28 R

(57) ABSTRACT

An equalizer assembly for compensating transmission losses of electronic communication signals includes a circuit board and a first equalizer and a second equalizer. Two input pins of each equalizer are parallel to each other. The input pins of the first equalizer are perpendicular to the input pins of the second equalizer.

### BACKGROUND

1. Technical Field

The present disclosure relates to equalizer assemblies used in electronic communication, and particularly to an equalizer assembly providing signal loss-compensation.

2. Description of Related Art

In electronic communications, high-frequency signals may be attenuated during transmission, this attenuation may lead to transmission loss. The transmission loss of high-frequency signals may result in data loss. Equalizers may be used to compensate for the attenuation of high-frequency signals. However, equalizers are expensive and for extended transmission distances, equalizers may be cost-prohibited.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the various figures.

FIG. 1 is a schematic view of an equalizer assembly, according to an embodiment.

FIG. 2 is a schematic view of an equalizer of the equalizer assembly of FIG. 1.

FIG. 3 is a compensation module of the equalizer shown in FIG. 2.

FIG. 4 is a schematic view of two equalizers of the equalizer assembly of FIG. 1 in a first orientation.

FIG. 5 is a schematic view of two equalizer of the equalizer assembly of FIG. 1 in a second orientation.

FIG. 6 is a schematic view of an equalizer assembly, according to another embodiment.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

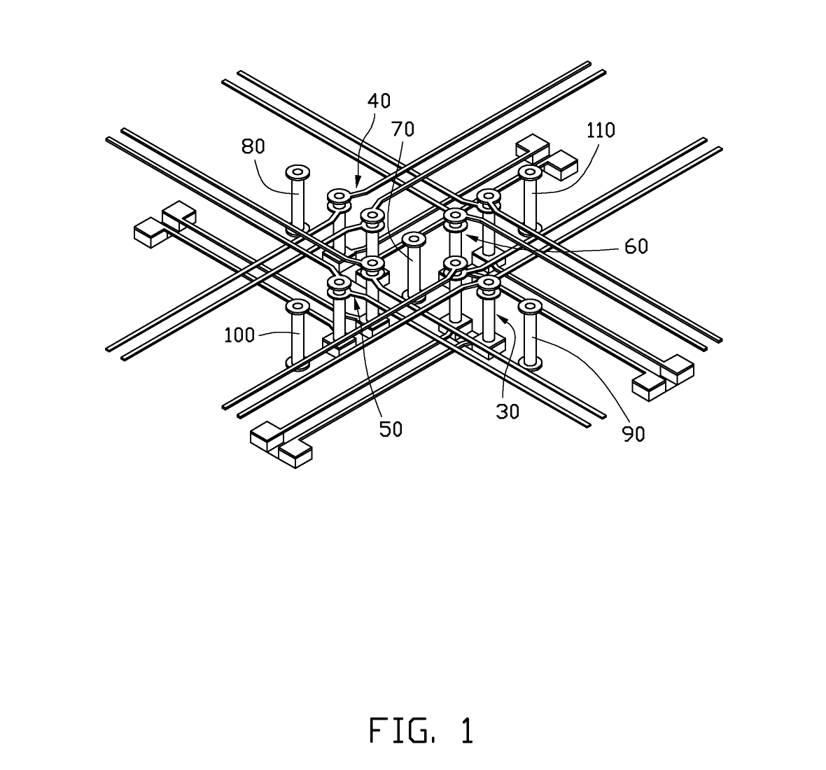

FIG. 1 is a schematic view of an equalizer assembly, according to an embodiment. The equalizer assembly can be used in an electronic device, for example, a personal computer (PC) or a mobile phone, to improve electronic communication quality. When high-frequency signals are transmitted in the electronic device, the equalizer assembly can compensate for attenuation of the high-frequency signals.

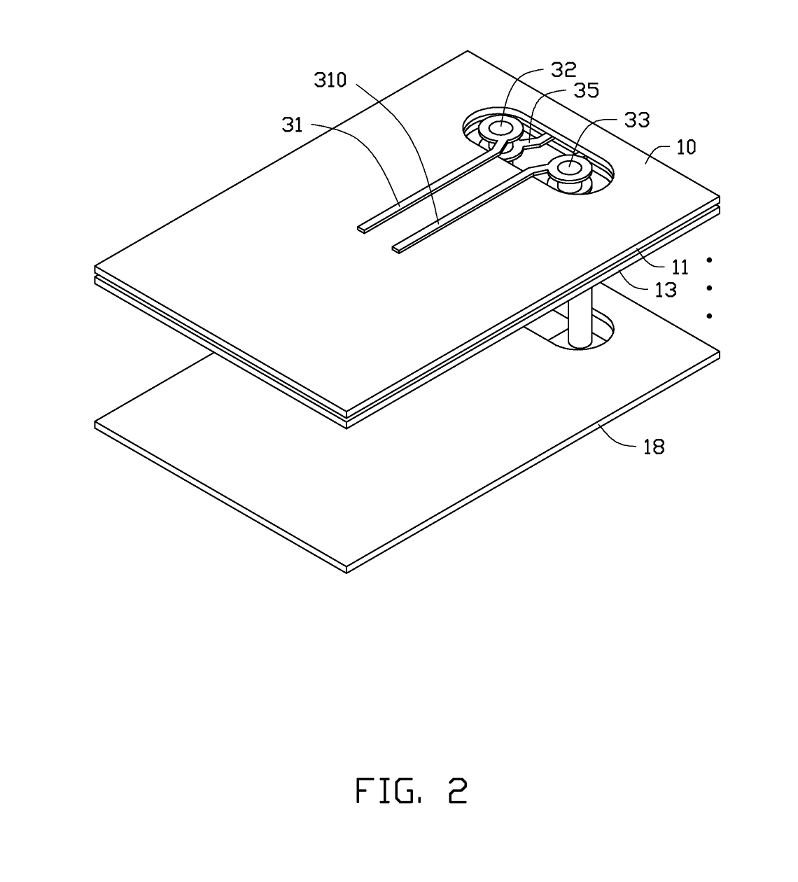

FIG. 2 shows that the equalizer assembly includes a circuit board 10 and four equalizers 30, 40, 50, and 60 mounted in the circuit board 10, and five ground vias 70, 80, 90, 100, and 110. In this embodiment, the circuit board 10 is a multilayer circuit board. In FIG. 2, only a top signal layer 11, a middle layer 13, and a bottom layer 18 of the circuit board 10 are shown.

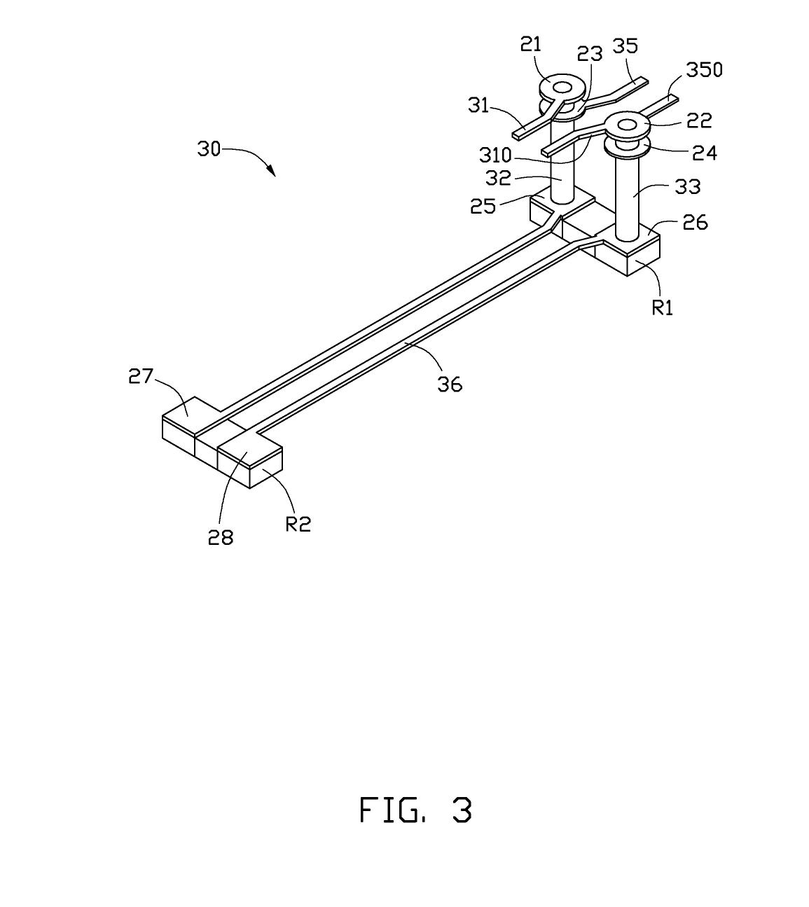

The four equalizers 30, 40, 50, and 60 have the same structures. FIGS. 2 and 3 show that the equalizer 30 includes a first input pin 31, a second input pin 310, a first signal via 32, a second signal via 33, a first output pin 35, a second output pin 350, a pair of micro-strips 36, a first resistor R1, and a second resistor R2.

The first input pin 31, the second input pin 310, the first signal via 32, the second signal via 33, the first output pin 35, the second output pin 350, and the micro-strips 36 are all made of conductive material, such as metal. The first signal via 32 and the second signal via 33 extend through the circuit board 10. The first signal via 32 is electrically connected to the top layer 11, the middle layer 13, and the bottom layer 18 through pads 21, 23, and 25 respectively. The second signal via 33 is electrically connected to the top layer 11, the middle layer 13, and the bottom layer 18 through pads 22, 24, and 26 respectively.

The first input pin 31 and the second input pin 310 are electrically connected to the pads 21 and 22, respectively. In the embodiment, the first input pin 31 and the second input pin 310 are substantially planar sheets, and arranged on an outer surface of the top signal layer 11. The first output pin 35 and the second output pin 350 are electrically connected to the pads 23 and 24, respectively. In the embodiment, the first output pin 35 and the second output pin 350 are substantially planar sheets, and arranged on a surface of the middle layer 13. Furthermore, the first input pin 31 and the first output pin 35 are arranged on a same line. The second input pin 310 and the second output pin 350 are arranged on a same line.

The pads 25 and 26 are electrically connected to two terminals of the resistor R1, respectively. Two pads 27 and 28 are mounted on a same side of the pads 25 and 26. A line between the pads 25 and 27 is parallel to a line between the pads 26 and 28. The pads 27 and 28 are electrically connected to two terminals of the resistor R2, respectively.

The micro-strips 36 are respectively connected to the pads 25 and 26 with first ends. Second ends of the pair of micro strips 36 are respectively connected to two terminals of the resistor R2 through the pads 27 and 28. The resistors R1 and R2 are arranged on an outer surface of the bottom layer 18.

In use, a high-frequency electronic communication signal (e.g., a differential signal) transmitted through the signal layers 11 of the circuit board 10 is received by the first input pin 31 and the second pin 310. A first part of the signal is transmitted to the first output pin 35 and the second output pin 350 directly. A second part of the signal is transmitted to the first resistor R1 through the first signal via 32 and the second signal via 33, and is reflected back to the first output pin 35 and the second output pin 350 by the first resistor R1. Thus, the second part of the signal is outputted from the first output pin 35 and the second output pin 350 to enhance the first part of the signal, and the output of the equalizer 100 obtains one stage of compensation. A third part of the signal is transmitted to the second resistor R2 through the first signal via 32, the second signal via 33, the resistor R1, and the micro-strips 36, and is reflected back to the first output pin 35 and the second output pin 350 by the second resistor R2. Thus, the third part of the signal is outputted from the first output pin 35 and the second output pin 350 to further enhance the first part of the signal, and the output of the equalizer 100 is given a second stage of compensation. In this way, transmission losses of the signal can be effectively compensated.

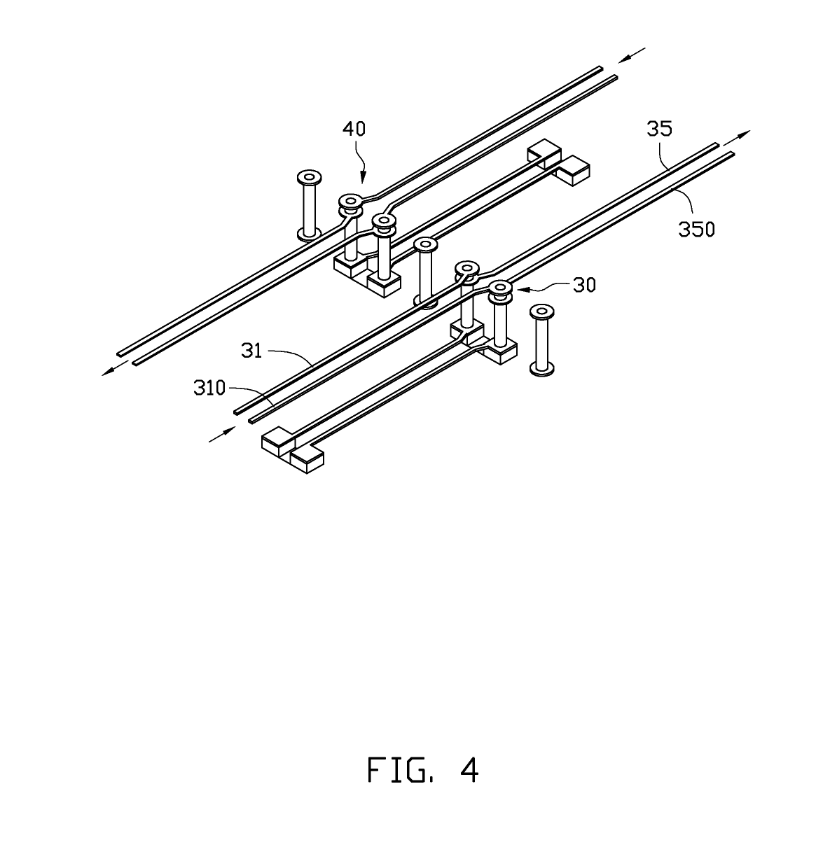

FIG. 4 shows that the equalizer 30 is parallel to the equalizer 40. All of the signal vias of the equalizers 30 and 40 are arranged on a same line. Transmission directions in the equalizers 30 and 40 are different. In detail, a first path of signal is received by the first input pin 31 and second input pin 310 of the equalizer 30, and then is processed by the equalizer 30. The processed signal is outputted from the first output pin 35 and the second output pin 350 of the equalizer 30. A second path of signal is received by the first and second input pins of the equalizer 40, and then is processed by the equalizer 40. The processed signal is outputted from the first and second output pins of the equalizer 40.

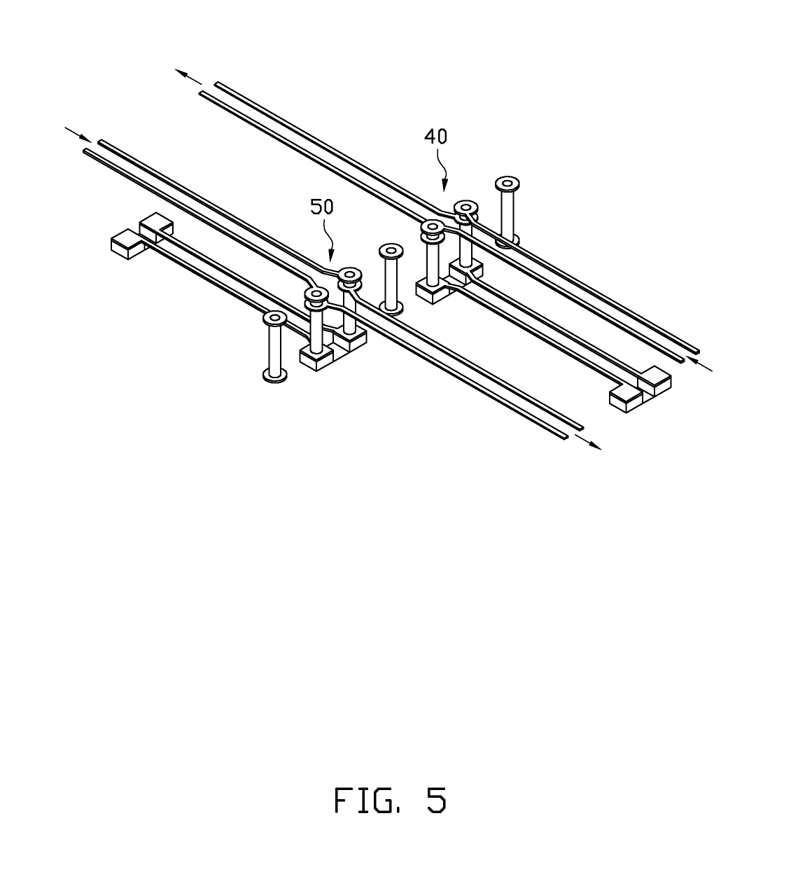

FIG. 5 shows that the equalizer 50 is parallel to the equalizer 60. All of the signal vias of the equalizers 50 and 60 are arranged on a same line. Transmission directions in the equalizers 50 and 60 are different. In detail, a third path of signal is received by the first and second input pins of the equalizer 50, and then is processed by the equalizer 50. The processed signal is outputted from the first and second output pins of the equalizer 50. A fourth path of signal is received by the first and second input pins of the equalizer 60, and then is processed by the equalizer 60. The processed signal is outputted from the first and second output pins of the equalizer 60. Furthermore, the equalizer 30 is perpendicular to the equalizer 50.

FIG. 1 shows that the five ground vias 70, 80, 90, 100, and 110 are close to the four equalizers 30, 40, 50, and 60, respectively. Each ground via is electronically connected to a ground layer of the circuit board 10. In detail, the ground vias 70, 80, and 90 and the signal vias of the equalizers 30 and 40 are arranged in a same line. The ground vias 100, 70, and 110 and the signal vias of the equalizers 50 and 60 are arranged in a same line. The ground via 70 is arranged among the equalizers 30, 40, 50, and 60. The ground via 90 is arranged on a side of the equalizer 30 away from the equalizer 40. The ground via 80 is arranged on a side of the equalizer 40 away from the equalizer 30. The ground via 100 is arranged on a side of the equalizer 50 away from the equalizer 60. The ground via 110 is arranged on a side of the equalizer 60 away from the equalizer 50.

As detailed above, when electronic communication signals pass through the equalizer assembly, each equalizer provides two stages of compensation to the electronic communication signals. Furthermore, the equalizer 30 is parallel to the equalizer 40, the equalizer 50 is parallel to the equalizer 60, and the equalizer 30 is perpendicular to the equalizer 50, as such reducing interference between the first to fourth path signals.

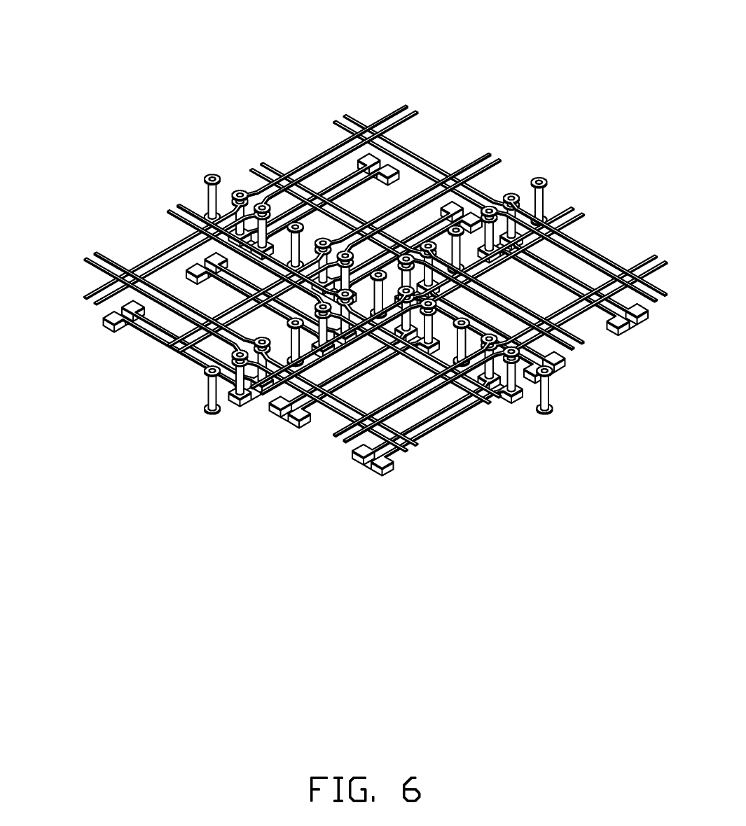

FIG. 6 shows that another embodiment of an equalizer assembly includes eight equalizers. The eight equalizers are arranged in an array including four rows and four columns. Correspondingly, the equalizer assembly includes nine ground vias. In other embodiments, the equalizer assembly may include more than eight equalizers or less than eight equalizers (such as two equalizers). When the equalizer assembly includes two equalizers, one of the two equalizers is perpendicular to the other equalizer, such as the equalizer 30 and the equalizer 60.

It is to be further understood that even though numerous characteristics and advantages of the present embodiments have been set forth in the foregoing description, together with details of structures and functions of various embodiments, the disclosure is illustrative only, and changes may be made in detail, especially in matters of arrangement of parts within the principles of the present invention to the full extent indicated by the broad general meaning of the terms in which the appended claims are expressed.

What is claimed is:

1. An equalizer assembly for compensating transmission loss of electronic communication signals, comprising:
a circuit board configured to transmit the electronic communication signals; and
a first equalizer and a second equalizer mounted in and electrically connected to the circuit board, wherein each equalizer comprises a first input pin, a second input pin, a first signal via, a second signal via, a first resistor, a second resistor, a first output pin, a second output pin, and a pair of micro-strips; the first and second signal vias extend through the circuit board, the first signal via is electrically connected to a top layer of the circuit board through a first pad, the first signal via is electrically connected to a middle layer of the circuit board through a second pad, the first signal via is electrically connected to a bottom layer of the circuit board through a third pad; the second signal via is electrically connected to the top layer through a fourth pad, the second signal via is electrically connected to the middle layer through a fifth pad, the second signal via is electrically connected to the bottom layer through a sixth pad; the first input pin is electrically connected to the first pad, the second input pin is electrically connected to the fourth pad, the first output pin is electrically connected to the second pad, the second output pin is electrically connected to the fifth pad; two terminals of the first resistor are electrically connected to the third and sixth pads respectively; a seventh pad and an eighth pad are arranged on the bottom layer and a same side of the third and sixth pads, a line between the seventh and third pads is parallel to a line between the eighth and sixth pads; two terminals of the second resistor are electrically connected to the seventh and eighth pads respectively; first terminals of the pair of micro-strips are electrically connected through the first resistor, second terminals of the pair of micro-strips are electrically connected through the second resistor, the first and second resistors are arranged on the bottom layer;
wherein the first input pin is parallel to the second input pin of each equalizer, the first input pin of the first equalizer is perpendicular to the first input pin of the second equalizer; wherein the first output pin is parallel to the second output pin of each equalizer, the first output pin of the first equalizer is perpendicular to the first output pin of the second equalizer.

2. The equalizer assembly of claim 1, further comprising at least a first ground via, a second ground via, and a third ground via, wherein the first ground via is arranged between the first equalizer and the second equalizer, the second ground via is arranged on a side of the first equalizer away from the second equalizer, the third ground via is arranged on a side of the second equalizer away from the first equalizer; the first to third ground vias are grounded.

3. The equalizer assembly of claim 2, wherein the first to third ground vias and the first and second signal vias of the first and second equalizers are arranged in a same line.

4. The equalizer assembly of claim 1, wherein the first input pin and the first output pin of the first equalizer are arranged in a same line, the second input pin and the second output pin of the first equalizer are arranged in a same line, the first input pin and the first output pin of the second equalizer are arranged in a same line, the second input pin and the second output pin of the second equalizer are arranged in a same line.

5. The equalizer assembly of claim 1, wherein the first and second input pins of the first and second equalizers are substantially planar sheets.

6. The equalizer assembly of claim 1, wherein the first and second input pins of the first and second equalizers are arranged on an outer surface of the top layer.

7. The equalizer assembly of claim 1, wherein the first and second output pins of the first and second equalizers are substantially planar sheets.

8. The equalizer assembly of claim 1, wherein the first and second output pins of the first and second equalizers are arranged on the middle layer.

9. The equalizer assembly of claim 1, further comprising a third equalizer and a fourth equalizer, wherein each of the third and fourth equalizers has a same structure with each of the first and second equalizers; a first input pin of the third equalizer is parallel to a first input pin of the first equalizer, a second input pin of the third equalizer is parallel to a first input pin of the first equalizer; a first input pin of the fourth equalizer is parallel to a first input pin of the second equalizer, a second input pin of the fourth equalizer is parallel to a first input pin of the second equalizer; transmission directions of signals in the first and third equalizers are different, transmission directions of signals in the second and fourth equalizers are different.

10. The equalizer assembly of claim 9, wherein the first input pin and the first output pin of the third equalizer are arranged on a same line, the second input pin and the second output pin of the third equalizer are arranged on a same line, the first input pin and the first output pin of the fourth equalizer are arranged on a same line, the second input pin and the second output pin of the fourth equalizer are arranged on a same line.

11. The equalizer assembly of claim 9, further comprising first to fifth ground vias, wherein the first ground via is arranged between the first to fourth equalizers, the second ground via is arranged on a side of the first equalizer away from the second equalizer, the third ground via is arranged on a side of the second equalizer away from the first equalizer, the fourth ground via is arranged on a side of the third equalizer away from the fourth equalizer, the fifth ground via is arranged on a side of the fourth equalizer away from the third equalizer; wherein the first to fifth ground vias are grounded.

12. The equalizer assembly of claim 11, wherein the first to third ground vias and the first and second signal vias of the first and second equalizers are arranged on a same line, the second, fourth, and fifth ground vias and the first and second signal vias of the third and fourth equalizers are arranged on a same line.
